(19) United States
(12) Patent Application Publication
(10) Pub. No.: US 2022/0126483 A1
(43) Pub. Date: Apr. 28, 2022

(54) A MOULD ASSEMBLY FOR A SKIMMER BOX LID

(71) Applicant: SKIMMER LIDS PTY LTD., Queensland (AU)

(72) Inventor: William Geoffrey FREEMAN, Queensland (AU)

(21) Appl. No.: 17/439,828

(22) PCT Filed: Mar. 20, 2020
(86) PCT No.: PCT/AU2020/000021

§ 371 Date: Sep. 16, 2021

(30) Foreign Application Priority Data
Mar. 20, 2019 (AU) 2019900929

(51) Int. Cl. B29C 33/00

(52) U.S. Cl. CPC B29C 33/0033

(57) ABSTRACT

A mould assembly for a skimmer box lid includes a mould including a floor and a sidewall extending from the floor, the floor and sidewall defining a mould cavity into which a settable material can be introduced. The floor defines at least one aperture. The assembly includes at least one mould insert having a tubular body that is configured for attachment to the floor to extend from the floor to a height that is at least substantially equivalent to a height of the sidewall, the tubular body defining an elongate passage to be in register with a respective aperture such that, when the settable material is introduced into the mould cavity and subsequently sets, the mould body, the, or each, mould insert, and the settable material form the skimmer box lid with the, or each, passage extending through the skimmer box lid so that a suitable tool can be used to lift the skimmer box lid.

### FIELD OF THE INVENTION

Various embodiments of a mould assembly for a skimmer box lid, a mould insert for a mould assembly for a skimmer box lid and a method of forming a skimmer box lid are described in this specification.

### BACKGROUND OF THE INVENTION

Skimmer box lids are used to cover or close a skimmer box, weir or drain of a swimming pool or some other water reservoir. They can be removed to provide access to the skimmer box, weir or drain for maintenance, cleaning and the removal or attachment of accessories, such as cleaners and basket filters.

Conventional skimmer box lids can be conspicuous. This is regarded as undesirable in various architectural arrangements. Skimmer box lids should not be conspicuous when a clean, minimalist aesthetic is sought. In such arrangements, the skimmer box lid should have the appearance of a tile. This can be achieved by placing a support frame in an opening into the skimmer box. A tile can then be positioned in the support frame to close the opening. The tile has an opening or some other formation so that the tile can be removed, either by hand, or with a suitable tool. The tile itself can be seated in a further frame so that the tile is protected from damage. Such an arrangement requires that the tile be cut or shaped. It can be difficult to achieve the required aesthetics with such cutting or shaping. Furthermore, such cutting and shaping can delay installation of a skimmer box lid. In addition, it can be difficult to match colours properly, particularly when installing a skimmer box lid.

### SUMMARY OF THE INVENTION

According to a first aspect of the invention, there is provided a mould assembly for a skimmer box lid, the mould assembly comprising:

a mould including a floor and a sidewall extending from the floor, the floor and sidewall defining a mould cavity into which a settable material can be introduced;

the floor defining at least one aperture; and

at least one mould insert having a tubular body that is configured for attachment to the floor to extend from the floor to a height that is at least substantially equivalent to a height of the sidewall, the tubular body defining an elongate passage to be in register with a respective aperture such that, when the settable material is introduced into the mould cavity and subsequently sets, the mould body, the, or each, mould insert, and the settable material form the skimmer box lid with the, or each, passage extending through the skimmer box lid so that a suitable tool can be used to lift the skimmer box lid.

The, or each, mould insert may include a clipping mechanism arranged on the tubular body so that the mould insert can be attached to the floor by being clipped onto a periphery of the aperture.

The, or each, aperture may open at a lower edge of the floor, such that the floor and the sidewall define a notch at the, or each, aperture. The clipping mechanism may include a clip formation that can be clipped into the notch.

The, or each, aperture may have a rectangular profile and the tubular body of the, or each, mould insert may have a rectangular cross section, such that the tubular body can be received through the aperture.

The clip formation may be positioned on one side of the tubular body and the clipping mechanism may include a lug that is positioned on an opposite side of the tubular body, such that the lug can be positioned at one end of the aperture, proximally with respect to the notch, and the mould insert can be pivoted so that the clip formation clips into the notch.

Stabilising formations may be arranged on the tubular body to bear against the floor when the clip formation clips into the notch.

The mould assembly may include at least one retention member that extends into the mould cavity and is shaped to retain the settable material in the mould cavity once the settable material has set. The, or each, retention member may project from the floor. The floor may define at least one retention plug aperture and the, or each, retention member may be a retention plug that can be plugged into the respective retention plug aperture to be retained with respect to the floor.

According to a second aspect of the invention, there is provided a mould insert for a mould assembly for a skimmer box lid, the mould assembly having a mould including a floor and a sidewall extending from the floor, the floor and the sidewall defining a mould cavity into which a settable material can be introduced, the floor defining at least one aperture, the mould insert comprising:

a tubular body defining an elongate passage and being configured for attachment to the floor to extend from the floor to a height that is at least substantially equivalent to a height of the sidewall, such that the passage is in register with a respective aperture, and such that, when the settable material is introduced into the mould cavity and subsequently sets, the mould body, the or each mould insert, and the settable material form the skimmer box lid with the, or each, passage extending through the skimmer box lid so that a suitable tool can be used to lift the skimmer box lid.

The mould insert may include a clipping mechanism arranged on the tubular body so that the mould insert can be attached to the floor by being clipped onto a periphery of the aperture. The clipping mechanism may include a clip formation that can be clipped into a notch, the, or each, aperture opening at a lower edge of the floor such that the floor and the sidewall define the notch.

The tubular body may have a rectangular cross-section and the, or each, aperture may have a rectangular profile so that the tubular body can be received through the aperture.

The clip formation may be positioned on one side of the tubular body such that the lug can be positioned at an inner end of the aperture and the mould insert can be pivoted so that the clip formation clips into the notch.

Stabilising formations may be arranged on the tubular body to bear against the floor when the clip formation clips into the notch.

According to a third aspect of the invention, there is provided a method of forming a skimmer box lid using the mould assembly of the first aspect, the method including the step of introducing the settable material into the mould cavity.

According to a fourth aspect of the invention, there is provided a skimmer box lid that comprises the mould assembly of the first aspect and a settable material in the mould cavity.

### BRIEF DESCRIPTION OF THE DRAWINGS

FIG. 1 shows a view, from above, of an embodiment of a mould assembly for a skimmer box lid, positioned in a skimmer lid support frame.

FIG. 2 shows a mould of the mould assembly of FIG. 1, positioned in the support frame.

FIG. 3 shows an exploded, underside view of the mould assembly of FIG. 1, out of the support frame.

FIG. 4 shows a view, from above, of a further embodiment of a mould assembly for a skimmer box lid.

FIG. 5 shows an underside view of the mould assembly of FIG. 4.

FIG. 5a shows the detail “A” in FIG. 5.

FIG. 6 shows a mould of the mould assembly of FIG. 4, in the support frame.

FIG. 7 shows an underside view of the mould of FIG. 6.

FIG. 8 shows an exploded, underside view of the mould assembly of FIG. 4.

FIG. 8a shows a detailed view of part of a sidewall and an edge of a floor, of a mould of the mould assembly of FIG. 8.

FIG. 9 shows a view, from above, of a further embodiment of a mould assembly for a skimmer box lid, in the support frame.

FIG. 10 shows a mould of the mould assembly of FIG. 9 in the support frame.

FIG. 11 shows an exploded, underside view of the mould assembly of FIG. 9.

FIG. 12 shows a perspective view of an example of a mould insert for a mould assembly for a skimmer box lid.

FIG. 13 shows a side view of the mould insert of FIG. 12.

FIG. 14 shows a perspective view, from below, of an example of a mould insert for use with a mould assembly for a skimmer box lid.

FIG. 15 shows a perspective view, from above, of the mould insert of FIG. 14.

FIG. 16 shows a side view of part of the mould insert of FIG. 14.

FIG. 17 shows a perspective view of a retention member or plug for use with a mould assembly for a skimmer box lid.

FIG. 18 shows a further perspective view of the retention plug of FIG. 17.

FIG. 19 shows an exploded top view of the mould assembly of FIG. 1 used with an example of a skimmer box lid support frame.

FIG. 20 shows an exploded top view of the mould assembly of FIG. 4 used with the skimmer box lid support frame of FIG. 19.

FIG. 21 shows an exploded top view of the mould assembly of FIG. 11 used with the skimmer box lid support frame of FIG. 19.

FIG. 22 shows a perspective view of a corner support for a skimmer box lid support frame for use with a skimmer box lid.

FIG. 23 shows a further perspective view of the corner support of FIG. 22.

FIG. 24 shows a top perspective view of a lifting tool for use with a skimmer box lid.

FIG. 25 shows a side view of the lifting tool of FIG. 24.

FIG. 26 shows a perspective view, from below, of a mould insert for use with a mould assembly for a skimmer box lid.

FIG. 27 shows a perspective view, from above, of the mould insert of FIG. 26.

FIG. 28 shows a perspective view, from above, of a skimmer box lid incorporating the mould assembly of FIG. 4.

### DETAILED DESCRIPTION

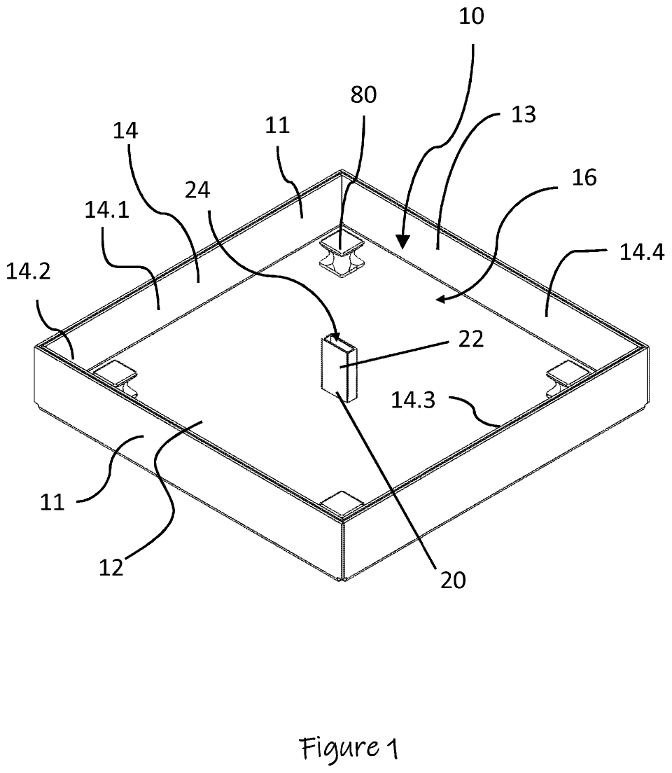

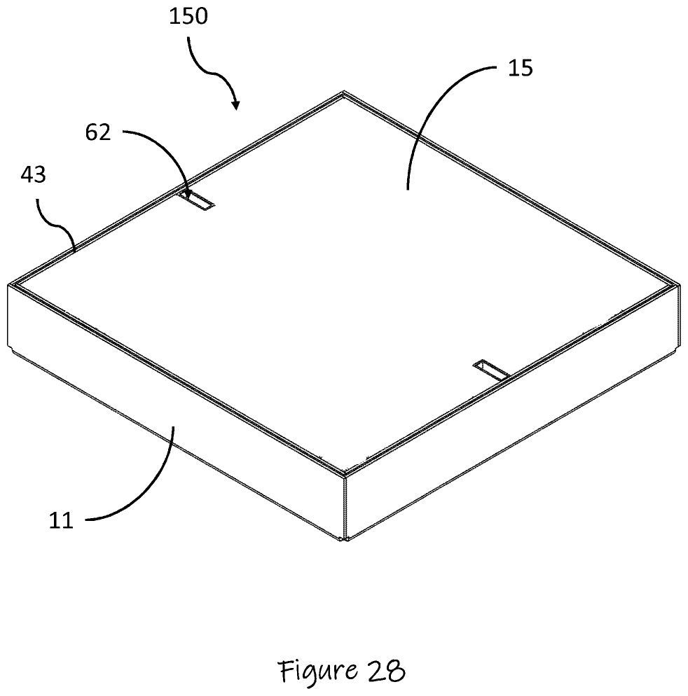

In FIGS. 1, 2 and 3, reference numeral 10 generally indicates an embodiment of a mould assembly for a skimmer box lid. The mould assembly 10 includes a mould 13. The mould 13 has a floor 12 and a sidewall 14 extending generally orthogonally from a periphery of the floor 12. The floor 12 and the sidewall 14 define a mould cavity 16 in which a settable material (shown as 15 in FIG. 28), such as a settable cementitious material, or any other material capable of setting into a product suitable for an area about a skimmer box, can be received. The floor 12 is planar, and generally spans the sidewall 14. The floor 12 is generally square. However, the floor 12 can be a number of different shapes, such as rectangular, hexagonal, round, et cetera. In such embodiments, the sidewall 14 has a corresponding profile. In use, the mould assembly 10 is seated in a skimmer lid support frame 11, which is positioned about a skimmer box opening. The frame 11 is configured so that the mould 13 can nest in the frame 11 and be supported on an inwardly extending ledge of the frame 11.

The sidewall 14 has four sidewall portions 14.1 to 14.4. Thus, the floor 12 and the sidewall portions 14.1 to 14.4 define the mould cavity 16 into which the settable material can be poured or otherwise introduced to mould or complete the skimmer box lid.

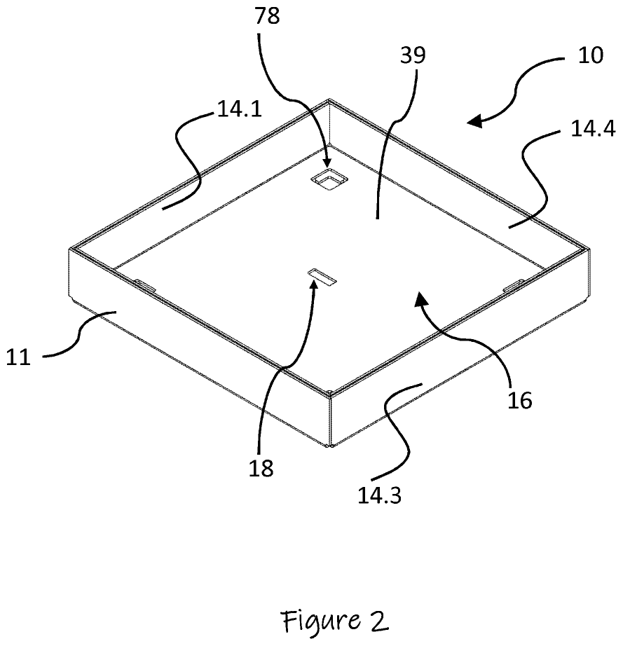

The floor 12 includes an aperture 18 (FIG. 2). The aperture 18 can have various shapes, for example, an elongate rectangular shape to form a slot as shown in FIG. 2. In this embodiment, the aperture 18 is positioned centrally in the floor 12. It is envisaged that the aperture 18 can also be offset if it is required to tilt the skimmer box lid, for example, due to weight.

A mould insert 20 is attached to the floor 12 to extend from the floor 12 to a height that is at least substantially equivalent to a height of the sidewall 14. The mould insert 20 includes a tubular body 22 defining an elongate passage 24. In this embodiment, the passage 24 has a transverse cross-section that is elongate, and a height that is generally the same as the height of the sidewall 14 of the mould 10, measured from an upper side of the floor 12 of the mould 10. The mould insert 20 is attached to the floor 12 such that the passage 24 is in register with the aperture 18.

The passage 24 can have different cross-sectional shapes, depending on a tool to be used to lift the skimmer box lid, for example. The mould insert 20 can engage with the floor 12 in various ways. For example, the mould insert 20 can include a clamping mechanism so that the mould insert 20 can clip onto a periphery of the aperture 18.

Once the settable material has been introduced into the mould cavity 16, to form a skimmer box lid, the mould insert 20 forms a passage which extends through the skimmer box lid incorporating the mould assembly 10, so that a suitable tool can be used to lift the skimmer box lid.

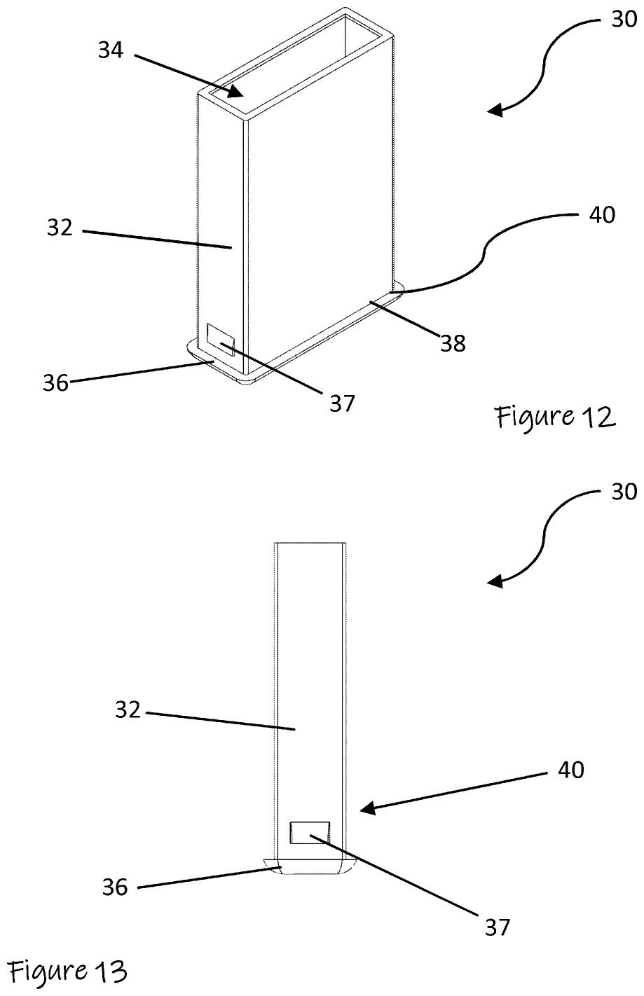

FIGS. 12 and 13 show a mould insert 30, for the mould assembly 10, that can be attached to the floor 12 to extend from the floor 12 to a height that is at least substantially equivalent to a height of the sidewall 14. The mould insert 30 is of a moulded plastics material. The plastics material is selected to have a certain level of resilience so that the insert 30 can accommodate a clipping operation. The mould insert 30 has a tubular body 32 defining a passage 34. The mould insert 30 can be attached to the floor 12 such that the passage 34 is in register with the aperture 18.

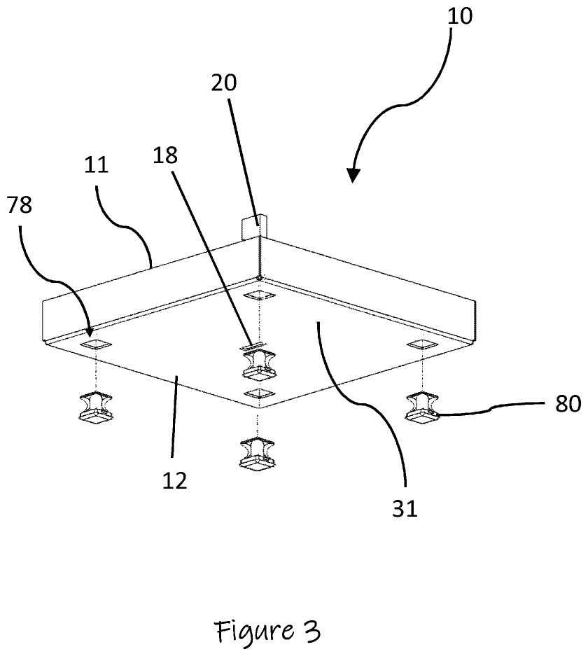

The body 32 has an elongate, transverse cross-section and a height that is generally the same as the height of the sidewall 14 measured from an upper side of the floor 12. The mould insert 30 has a lip 36 extending outwardly along a periphery 38 of a lower end 40 of the tubular body 32. When the tubular body 32 is inserted through the slot aperture 18, from underneath, the lip 36 abuts an underside 31 (FIG. 3) of the floor 12. The mould insert 30 has a clipping mechanism in the form of one or more clip formations 37 on the outer surface of the tubular body 32, spaced from the lip 36. The clip formations 37 are positioned and shaped so that, as the lip 36 moves into abutment with the underside 31, the formations 37 slide past a periphery of the aperture 18 and clip onto an upper side 39 (FIG. 2) so that the periphery is retained between the lip 36 and the formations 37, so retaining the mould insert 30 in position. The formations 37 can have wedge-shaped profiles, widening downwardly.

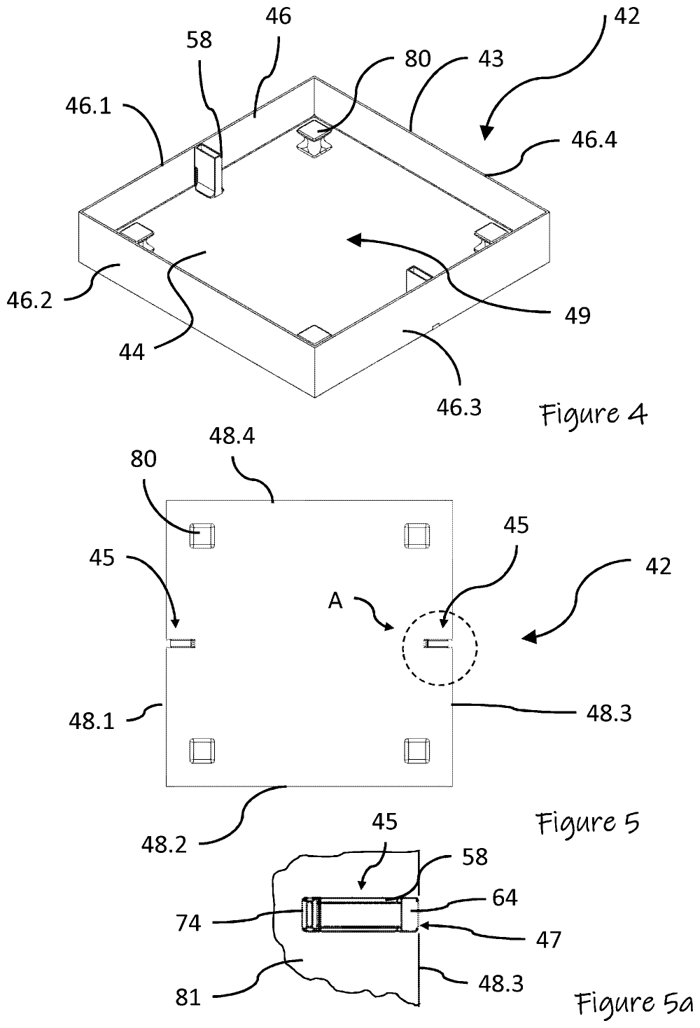

In FIGS. 4 to 8, a further embodiment of a mould assembly for a skimmer box lid is generally indicated by reference numeral 42. The mould assembly 42 includes a mould 43 having a floor 44 and a sidewall 46. The floor 44 extends below the sidewall 46, such that an outer side of the sidewall 46 is aligned with an edge of the floor 44.

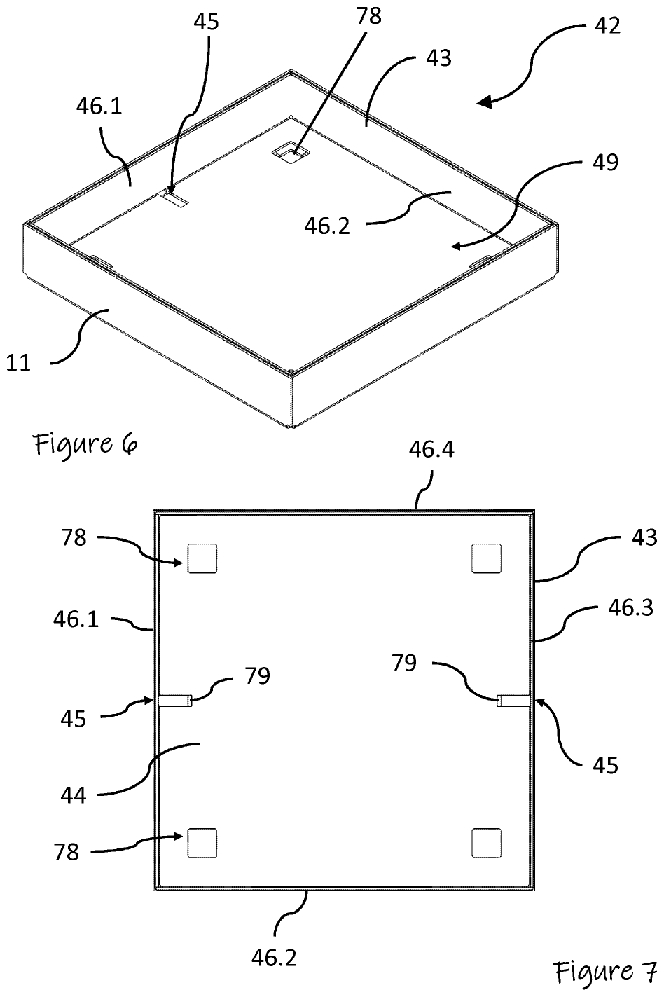

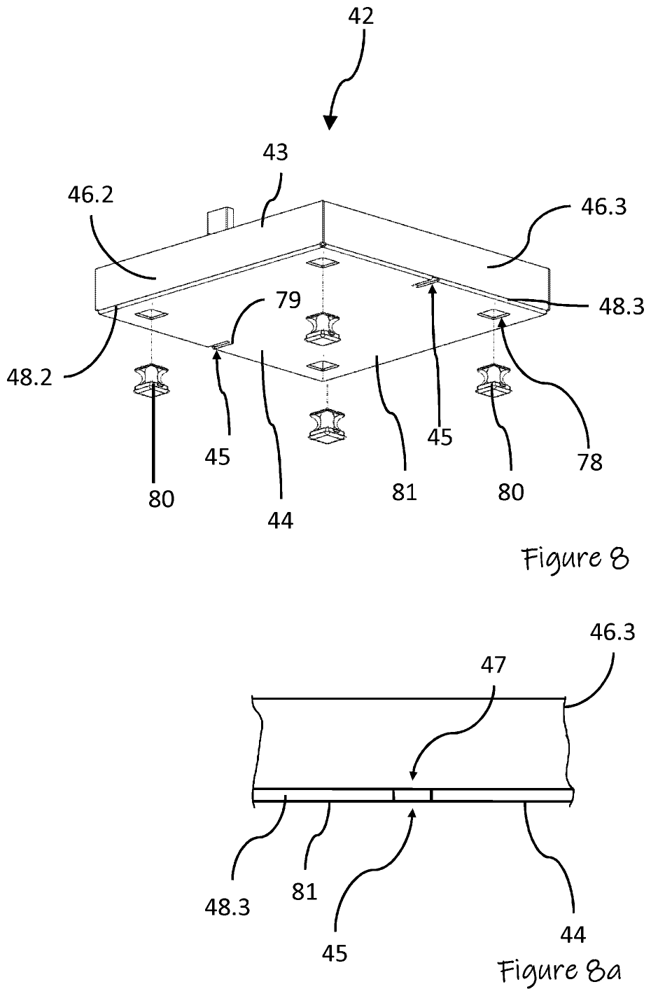

The sidewall 46 has a square profile, in plan, and includes four sidewall portions 46.1 to 46.4 so that the floor 44 and the sidewall 46 define a mould cavity 49 into which the settable material can be poured or otherwise introduced. The sidewall 44 can have differently shaped profiles, such as circular or polygonal. The floor 44 has two apertures 45 extending inwardly from respective, opposite edges 48.1, 48.3 of the floor 44 (FIG. 5). The apertures 45 can have various shapes. In this example, the apertures 45 are slotted. As shown in FIGS. 7, 8 and 8a, for example, the apertures 45 open below the sidewalls 46.1, 46.3. This forms a notch 47 (FIG. 8a) underneath the sidewalls 46.1, 46.3.

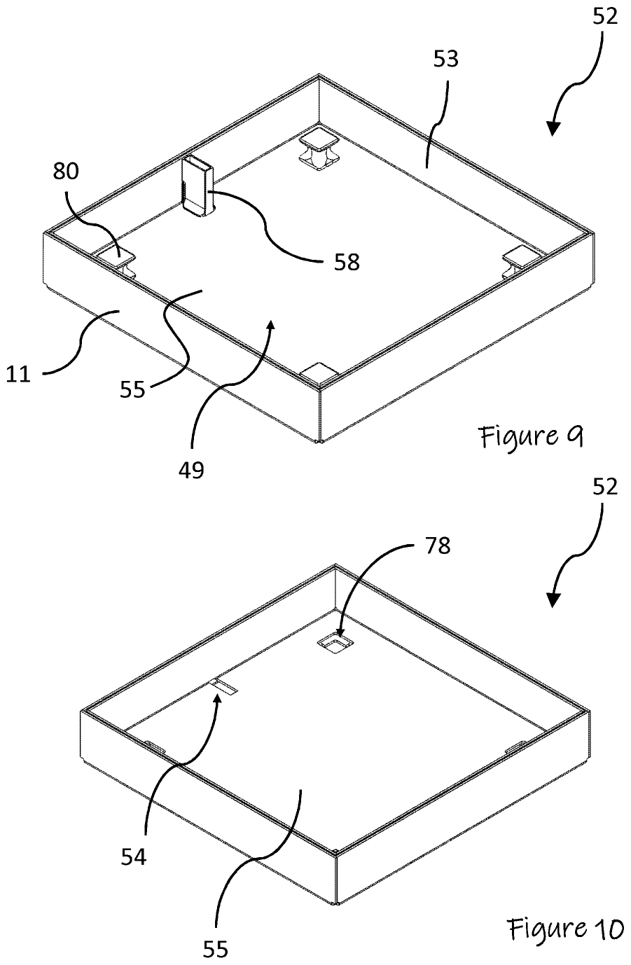

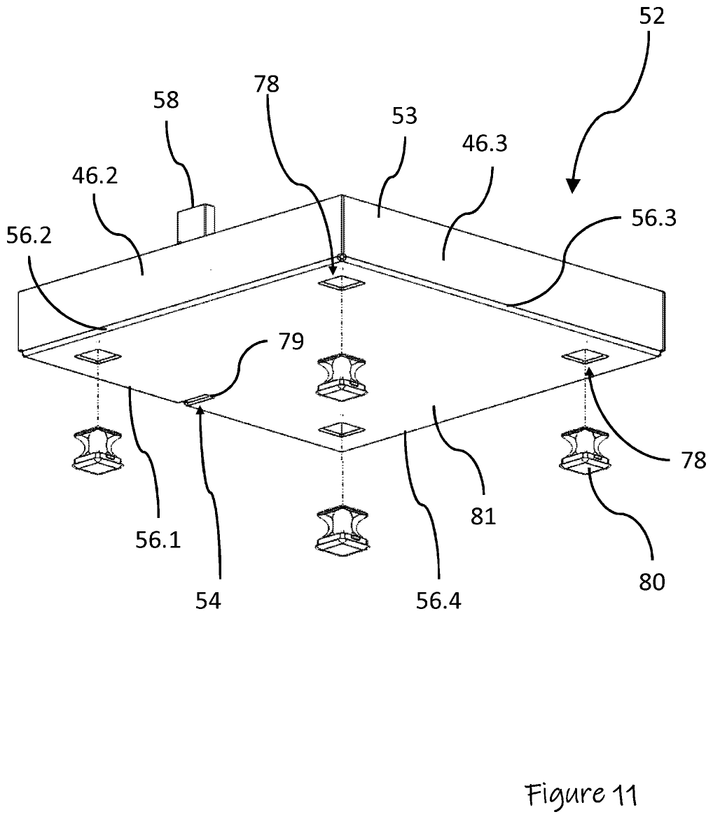

In FIGS. 9 to 11, a further embodiment of a mould assembly for a skimmer box lid is generally indicated by reference numeral 52. The mould assembly 52 includes a mould 53. In this embodiment, the mould 53 is generally identical to the mould 43, with the exception that it has a single aperture 54 extending inwardly from an edge 56.1 of a floor 55. The aperture 54 is identical to the aperture 45.

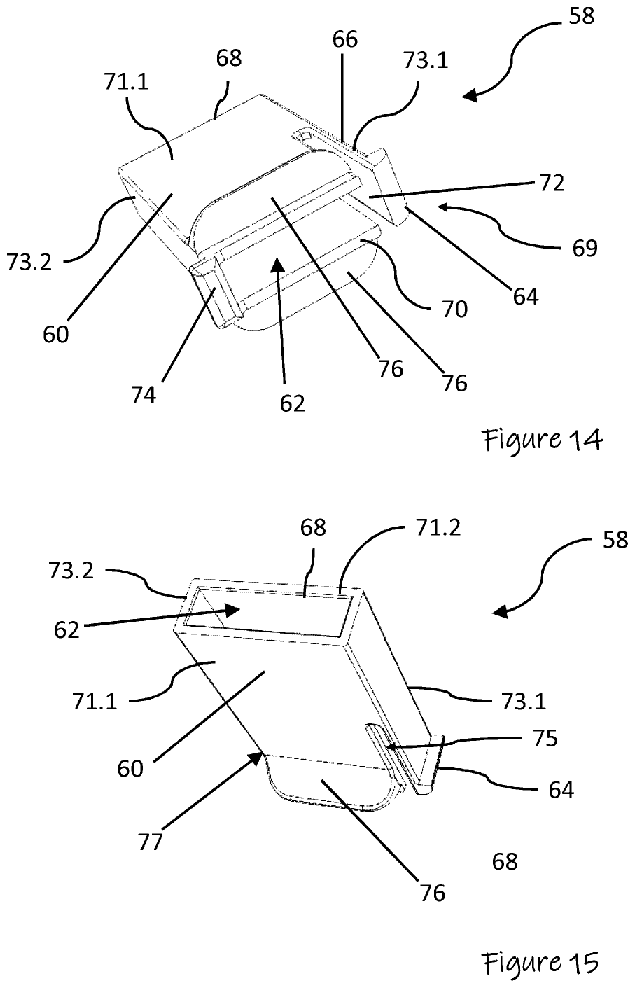

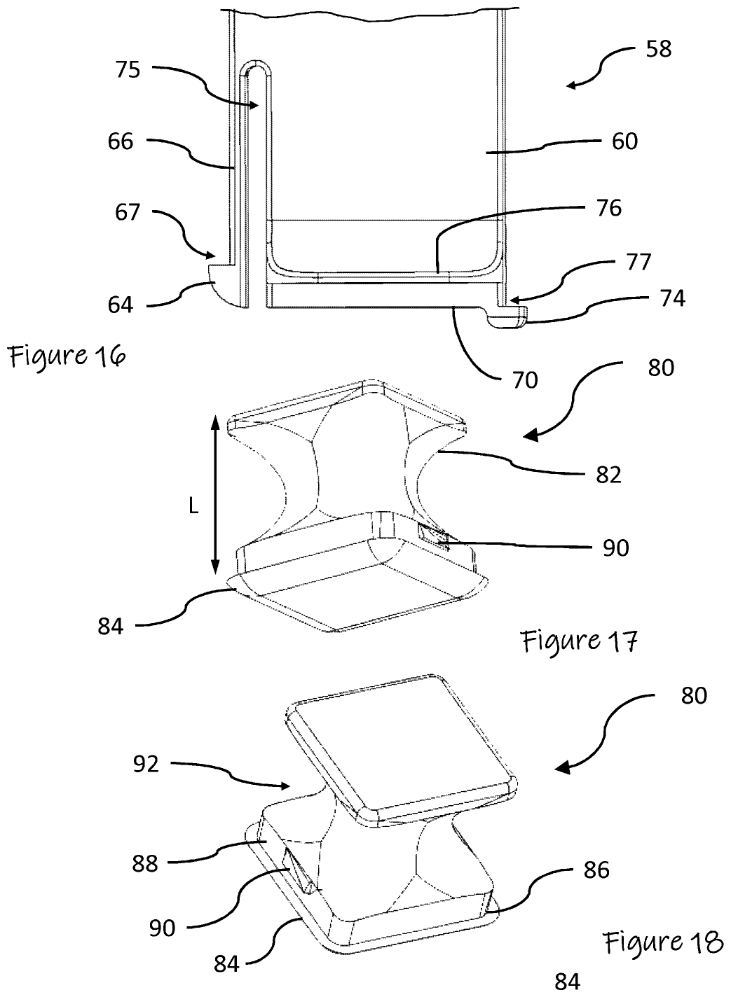

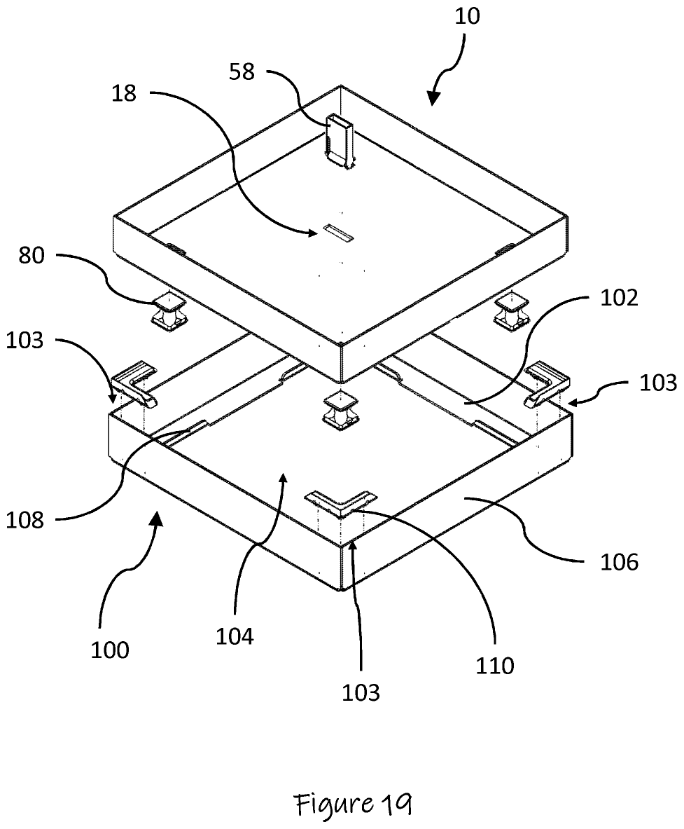

FIGS. 14, 15 and 16 show a further example of a mould insert 58 for the skimmer lid mould assembly 42, 52. The mould insert 58 can also be used with the skimmer lid mould assembly 10, or any skimmer lid mould assembly with an aperture in a mould that is configured to receive the mould insert 58 in a retentive manner. The mould insert 58 can be attached to the floor 44, 55 to extend from the floor 44, 55 to a height that is at least substantially equivalent to a height of the sidewall 46.

The mould insert 58 has a tubular body 60 defining an elongate passage 62. The passage 62 has an elongate rectangular transverse profile such that the passage 62 is slotted, and a height that is generally the same as the height of the sidewall 46 of the mould 43, 53, measured from an upper side of the floor 44, 55. In this embodiment, the mould insert 58 is configured for use with a mould that includes one or more apertures extending inwardly from an edge of the floor of the mould, for example the apertures 45, 54 of the moulds 43 and 53. The mould insert 58 can be attached to the floor 44, 55 such that the passage 62 is in register with the aperture 45, 54.

The tubular body 60 has an upper end 68 and a lower end 70. The tubular body 60 has a generally rectangular profile, with opposed major walls 71.1, 71.2 and opposed minor walls 73.1, 73.2. A clipping mechanism 69 is positioned at or near the lower end 70. The major walls 71 have respective, aligned slots 75 proximate the minor wall 73.1. Thus, a portion of the minor wall 73.1 forms a clip arm 66 of the clipping mechanism 69. As set out above, the material of the insert 58 is resiliently flexible, being a function of the material from which it is moulded or otherwise fabricated. Thus, the arm 66 is capable of being displaced, against a bias of the material, towards the minor wall 73.2.

The clipping mechanism 69 includes a clip member or formation 64 that extends laterally from the clip arm 66 at the lower end 70 of the tubular body 60. The formation 64 has a generally wedge-shaped or curved profile, tapering inwardly towards the lower end 70. The formation 64 and the clip arm 66 define a shoulder 67 (FIG. 16).

A lip or lug 74 extends downwardly and outwardly from the minor wall 73.2, with respect to the lower end 70. The lug 74 and the minor wall 73.2 define a shoulder 77 (FIG. 16) that is generally aligned with the lower end 70 of the tubular body 60.

The tubular body 60 has cross-sectional dimensions that correspond generally with the aperture 45, 54. Thus, the shoulder 77 can be brought into abutment with an inner edge 79 (FIG. 7) of the aperture 45, 54, with the lug 74 positioned against an outer side 81 (FIG. 8) of the floor 44, 55. The mould insert 58 is then tilted so that the formation 64 abuts the sidewall portion 46.1, 46.3, urging the arm 66 inwardly until the formation 64 reaches the aperture 45 and is driven outwardly, as a result of the resilience of the material of the mould insert 58, to engage the sidewall portion 46.1, 46.3 in the notch 47 (as shown in FIG. 5a). As can be seen in FIG. 16, the shoulder 67 and the shoulder 77 have a vertical differentiation. This differentiation is generally equivalent to a thickness of the floor 44, allowing for the differential positions of the lower edge of the sidewall 46 and the outer side 81 of the floor 44, 55. Stabilising members or stabilisers 76 extend from respective major walls 71.1, 71.2 and have lower surfaces that are positioned to engage the floor 44 to stabilise the mould insert 58 and to inhibit further movement of the mould insert 58. In other embodiments, the shoulders 67, 77 are aligned so that, for example, the insert 58 can be used with the aperture 18 or any other aperture that does not open under a sidewall, such that the shoulders 67, 77 can both abut the outer side 81.

It follows that the mould inserts 58 can readily be positioned by hand and without the need for any tools. This facilitates the use of the mould assembly on site, for example, to form the skimmer box lid.

The mould assembly 10, 42, 52 includes one or more retention members that extend into the mould cavity 49 to retain the settable material in the mould cavity 49, once it has set. Retention plug apertures 78 are defined by the floor 44 of the mould 13, 43, 53 and are configured to each receive a retention member in the form of a retention plug 80. The retention plug apertures 78 can be positioned at any location on the floor 44 of the mould 13, 43, 53. In one embodiment, the mould 43, 53 includes four apertures 78 positioned at or near respective corners of the floor 44.

The retention plug 80 is shown in detail in FIGS. 17 and 18. The retention plug 80 includes a body 82. An end cap 84 with chamfered edges is positioned on a lower end of the body 82. The end cap 84 and the body 82 define a shoulder 86. The body 82 has a profile that is dimensioned to permit the body 82 to be received through the associated aperture 78. The end cap 84 has a profile that is larger than the aperture 78 so that the shoulder 86 can be brought into abutment with the outer side 81 of the floor 44.

The body 82 has a base 88 that corresponds generally with the aperture 78, the base 88 and the end cap 84 defining the shoulder 86. The base 88 is dimensioned so that it can slide upwardly through the aperture 78 until the shoulder 86 bears against the outer side 81 of the floor 44, 55.

A clipping formation 90 is arranged on opposite sides of the base 88. Each clipping formation 90 tapers outwardly towards the shoulder 86 and terminates at a distance from the shoulder 86 that is generally equivalent to a thickness of the floor 44, 55. Thus, the body 82 can be inserted through the associated aperture 78 until the clipping formation 90 engages sides of the aperture 78 and, with further urging, the sides are retained between the clipping formations 90 and the shoulder 86.

The body 82 is shaped so that, once the settable material sets, the material is retained within the mould 10. To that end, the body 82 is shaped to define a narrowed or waisted portion 92.

A length L of the body 82 is less than a height of the side walls 46 so that the plugs 80 can be covered by the settable material.

The mould 10, 42, 52 can be used with a skimmer box lid support frame, as described in International Application Number PCT/AU2018/000149 (the “'149 Document”), the contents of which are incorporated entirely herein, by way of reference. In the '149 Document, there is described a skimmer box lid support frame, referred to as a “skimmer lid support 140”.

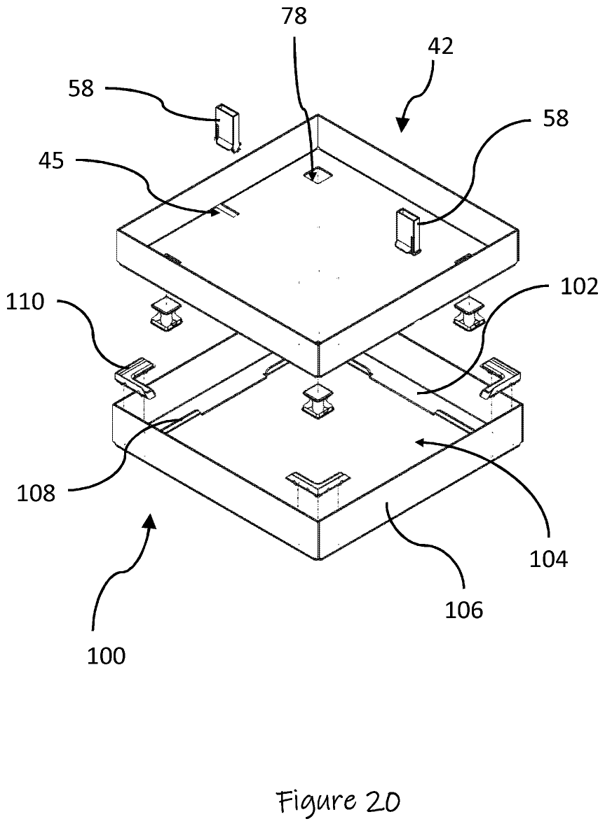

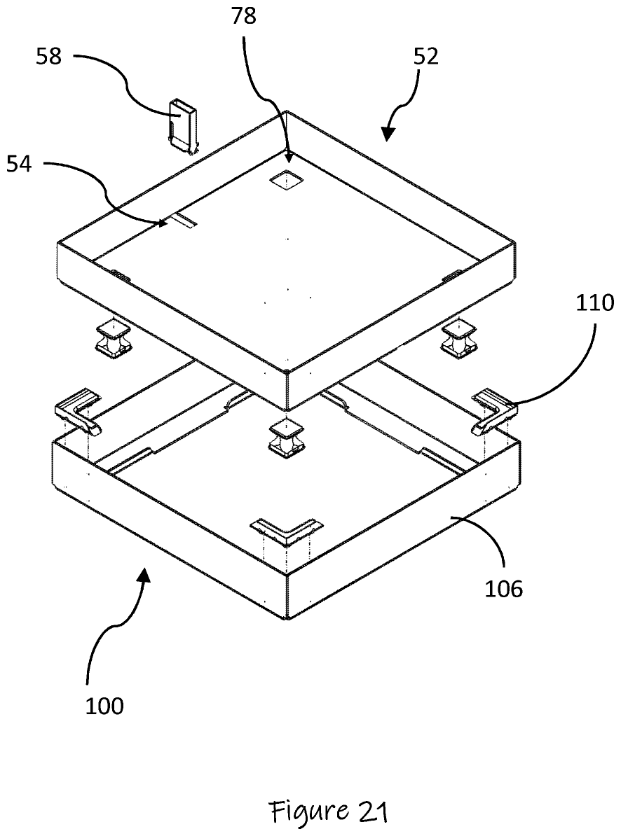

The skimmer box lid support frame is referenced herein with number 100. The support frame 100 is shown in FIGS. 19, 20 and 21. The support frame 100 includes a ledge or base 102. The base 102 defines an opening 104 for access to a skimmer box. A rim or sidewall 106 extends from a periphery of the base 102, generally orthogonally with respect to the base 102. In use, the support frame 100 is placed and secured over a skimmer box, in a recess in paving or flooring around a swimming pool or spa, the recess being appropriately sized and shaped to accommodate the support frame 100.

The frame 100 includes support members or tabs 108 arranged on the base 102 and extending upwardly from the base 102 to support a skimmer box lid incorporating the mould 10, 42, 52. The tabs 108 are formed at an interface of the base 102 and the opening 104, by shaping portions of the base 102 to form each of the tabs 108 which extend upwardly from a remainder of the base 102, substantially orthogonally to the remainder. Thus, the tabs 108 can be the result of a cutting and bending process carried out on the base 102, wherein cuts are made into the base 102 to demarcate the tabs 108, which are subsequently bent upwards. The tabs 108 can be bent upwardly to be generally parallel to portions of the side wall 106, opposite respective tabs 108. Thus, the tabs 108 are an integral part of the frame 100. It follows that the provision of the tabs 108 does not result in an additional weight of the frame 100. The frame 100 can be of a sheet material, such as sheet steel or sheet aluminium.

The tabs 108 are dimensioned so that when the skimmer box lid is positioned in the frame 100, the lid is spaced a predetermined distance from the base 102. This enables insertion and securing of a lifting device as described in the '149 Document.

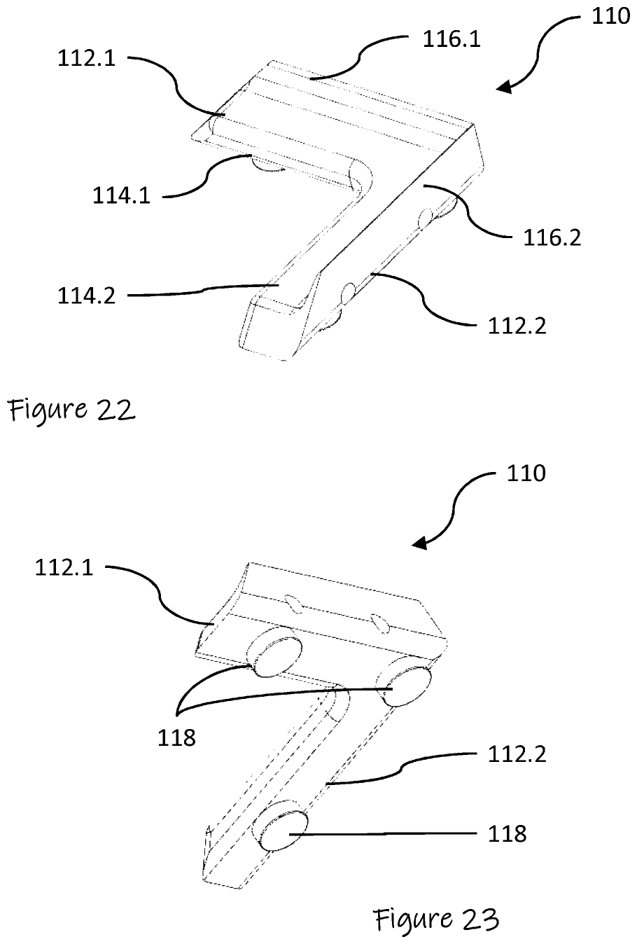

Instead, or in addition to, the tabs 108, discrete corner supports 110 are located in the base 102, in each corner 103 of the sidewall 106. Each corner support 110 includes two legs 112.1, 112.2 (FIGS. 22 and 23). The legs 112 connect generally orthogonally. Each leg 112.1,112.2 includes a support base 114.1, 114.2 and a wall 116.1, 116.2. Feet 118 project from underneath each leg 112.1, 112.2 to bear against the base 102. The feet 118 provide a spacing between the base 102 and the legs 112. This can facilitate ventilation, to inhibit the build-up of gas and/or to maintain a desired level of dryness within the arrangement.

The corner supports 110 may be of a resiliently flexible material to absorb shock. Furthermore, the corner supports 110 may be of a unitary, moulded configuration. In use, the corner supports 110 are positioned in respective corners 103.

Corresponding corner portions of the mould 10, 42, 52 can be lowered onto the corner supports 110 with the walls 116 interposed between the sidewalls 14, 46 and the side wall 106. Thus, the corner supports 110 serve to secure the skimmer box lid against lateral movement within the frame 100. The corner supports 110 can be of an electrically non-conductive material. This can serve to insulate the skimmer box lid from the support frame 100.

It is envisaged that mould inserts can be supplied separately from the mould. In such cases, it may be that the mould inserts require height adjustment to suit a height of the sidewalls 14, 46. In FIGS. 26 and 27, reference numeral 130 generally indicates a further example of a mould insert for use with the mould 13, 43, 53.

The mould insert 130 has a tubular body 132, having the same transverse dimensions as the tubular body 60. The tubular body 132 has a series of lines or recesses of weakness 134. These are positioned so that sections 136 of the tubular body 132, towards the upper end 68, can be snapped or broken off to provide the tubular body 132 with a height corresponding generally with a height of the sidewalls 14, 46, as described with reference to the mould insert 58.

In use, in a method of forming or fabricating a skimmer box lid, the mould 13, 43, 53 is fitted with the mould insert(s) 20, 30, 58, 130 and the retention plug(s) 80 as described above. The mould assembly 10, 42, 52 is then positioned on the corner supports 110 in the frame 100, as described above. Alternatively, the mould assembly 10, 42, 52 can be positioned on a different substrate, such as a workbench, before the skimmer box lid is positioned on the corner supports 110 or in the frame 11.

A settable material is introduced into the mould cavity 16, 49 and finished off in a suitable manner. Once the material has set, it is retained in the mould cavity 16, 49 by the retention plugs 80. The mould inserts 20, 30, 58 provide passages or slots through the settable material, which extend through the skimmer box lid. These slots enable insertion of one or more lifting devices (such as the lifting device described in the '149 Document) through the skimmer box lid to facilitate lifting of the lid from the frame 100 to allow access to an underlying skimmer box or drain.

In FIG. 28, reference numeral 150 generally indicates a skimmer box lid incorporating the mould assembly 42. The settable material is generally indicated with reference numeral 15.

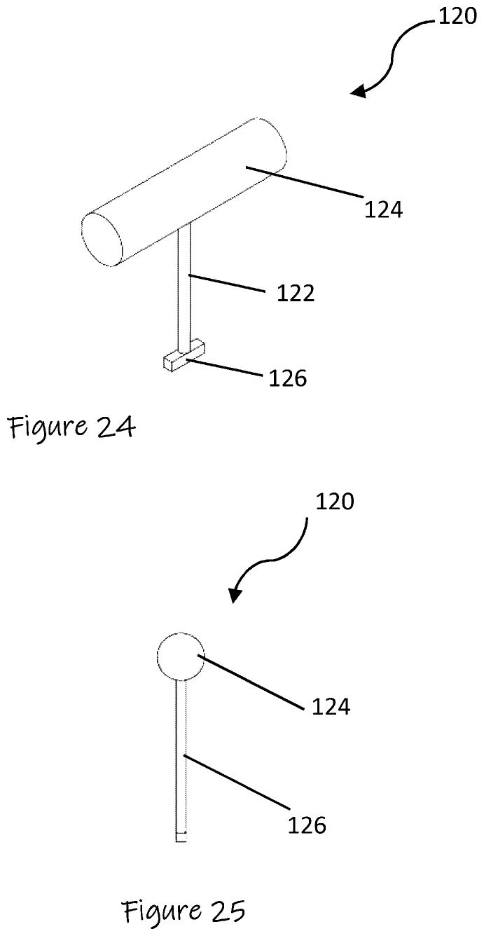

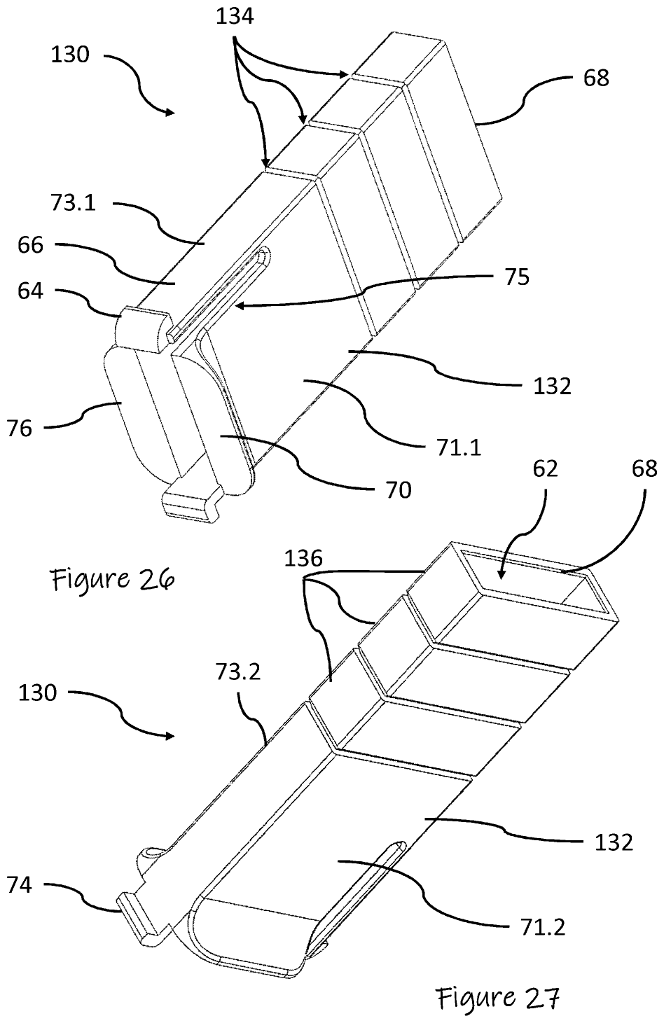

In one embodiment, the passages or slots are configured to suit a key or tool, such as that shown in FIGS. 24 and 25, and referred to generally by numeral 120. The tool 120 has a T-piece 122 extending from a handle 124. The T-piece 122 is manipulated so that it can be inserted through the slot and subsequently twisted so that a head 126 of the T piece 122 can engage an underside of the skimmer box lid, so that the lid can either be tilted or lifted using the tool 120. It is envisaged that other forms of tools could be used for insertion into the slot, manipulation and subsequent lifting of the skimmer box lid.

A skimmer box lid incorporating the mould assembly 10, 42, 52 and a suitable settable material, provide a skimmer box lid that can be used to match or complement surrounding paving or surfacing. Once the material has set, the material can be surface-finished with a suitable pattern and/or coating. For example, when the settable material is concrete, the finish can be one that is currently used to enhance the appearance of concrete. In one example, the concrete can be coloured. Other examples of a settable material are mortar and minerals that are bound with a suitable binder such as epoxy or polyurethane. The material can be selected to have a colour and texture that corresponds with the colour and texture of tiles used in proximity to the lid. For example, the material can be pre-selected to suit any of a range of various standard forms of tile. This allows the lid to blend into the surrounding environment so as not to be aesthetically jarring.

The mould can be of any number of different materials. These materials can be selected to have a resistance to physical damage which is higher than a resistance to physical damage than the settable material, once set. This has a number of uses. For example, the sidewall and the floor together can inhibit damage to the settable material, once set, which may be relatively brittle or frangible when compared with the material of the mould body. It will be appreciated that, in use, over time, the lid will be lifted up and placed on various surfaces. As a result, without any protection, the settable material could become damaged over time. For example, this could include chipping to corners which could negatively impact the aesthetic appearance of the skimmer box lid.

Furthermore, the fact that a lifting tool bears against the material of the mould protects the settable material from damage that could result from the lifting tool repeatedly digging into the settable material.

The mould can be of steel. For example, the mould can be of a stainless steel selected to be weather resistant. In various embodiments, the mould can be fabricated from steel plate. The steel plate can be between about 1 mm and 3 mm thick. For example, the steel plate can be about 2 mm thick.

In other embodiments, the mould can be fabricated of other materials, such as a plastics material or other forms of metal. The mould can be itself moulded or can be cast or machined.

The mould may have a variety of shapes. For example, the mould can be rectangular or square or circular in plan view. In other examples, the mould can have other shapes, such as hexagonal or octagonal, in plan view.

As set out above, the mould insert is a separate component of a plastics material. This allows the mould insert to be fabricated in a suitable moulding process, separate from the mould, described above. The mould is a relatively simple structure. It is to be appreciated that a mould in which the mould insert is incorporated as part of the mould, for example, welded to the mould floor, would be a relatively complicated component, in comparison, which would be relatively expensive and time-consuming to fabricate, when compared with the mould, described above, with effectively just sidewalls and a slotted floor. Apart, the mould and the mould inserts are relatively simple, with the mould insert lending itself to a plastics moulding operation. Also, the installer can have various combinations of the mould and the mould inserts at hand, without the need for combinations, in one piece, which could result in limited flexibility. For example, the installer could have a large number of identical mould inserts together with different forms of the mould, as described above. The fact that the mould inserts can be used with any of the different forms of mould provide the installer with convenient flexibility. Furthermore, the design of the mould inserts described above allows the installer easily to clip the mould inserts to the moulds, as necessary. In a similar operation, the installer can clip the retention plugs to the floor, in the manner described above.

It is to be understood that in various embodiments the mould is not detached from the settable material. This is not to be understood as detracting from the role of the mould, which is to be used to mould the settable material into a desired shape.

The appended claims are to be considered as incorporated into the above description.

In the above description, like reference numerals refer to like parts, unless otherwise specified. It follows that parts or components of embodiments can be interchanged, where reasonably feasible. The use of common reference numerals is not to be regarded as an indication that any components of one embodiment are essential for another embodiment and is for convenience only.

Throughout this specification, reference to any advantages, promises, objects or the like should not be regarded as cumulative, composite and/or collective and should be regarded as preferable or desirable rather than stated as a warranty.

Throughout the specification, including the claims, where the context permits, the term “comprising” and variants thereof such as “comprise” or “comprises” are to be interpreted as including the stated integer or integers without necessarily excluding any other integers.

When any number or range is described herein, unless clearly stated otherwise, that number or range is approximate. Recitation of ranges of values are to be considered as reciting, individually, each separate value falling within the range, unless otherwise indicated herein.

Words indicating direction or orientation, such as “front”, “rear”, “up”, “down”, “top”, “bottom”, “inner”, “outer”, et cetera, and their derivatives or synonyms, are used for convenience. The inventor(s) envisages that various embodiments can be used in a non-operative configuration, such as when presented for sale. Thus, such words are to be regarded as illustrative in nature, and not as restrictive.

The term “and/or”, e.g., “A and/or B” shall be understood to mean either “A and B” or “A or B” and shall be taken to provide explicit support for both meanings or for either meaning.

It is to be understood that the terminology employed above is for the purpose of description and should not be regarded as limiting. The described embodiments are intended to be illustrative of the invention, without limiting the scope thereof. The invention is capable of being practised with various modifications and additions as will readily occur to those skilled in the art.

1. A mould assembly for a skimmer box lid, the mould assembly comprising:
a mould including a floor and a sidewall extending from the floor, the floor and sidewall defining a mould cavity into which a settable material can be introduced;
the floor defining at least one aperture; and
at least one mould insert having a tubular body that is configured for attachment to the floor to extend from the floor to a height that is at least substantially equivalent to a height of the sidewall, the tubular body defining an elongate passage to be in register with a respective aperture such that, when the settable material is introduced into the mould cavity and subsequently sets, the mould body, the, or each, mould insert, and the settable material form the skimmer box lid with the, or each, passage extending through the skimmer box lid so that a suitable tool can be used to lift the skimmer box lid.

2. The mould assembly as claimed in claim 1, wherein the, or each, mould insert includes a clipping mechanism arranged on the tubular body so that the mould insert can be attached to the floor by being clipped onto a periphery of the aperture.

3. The mould assembly as claimed in claim 2, wherein the, or each, aperture opens at a lower edge of the floor, such that the floor and the sidewall define a notch at the, or each, aperture.

4. The mould assembly as claimed in claim 3, wherein the clipping mechanism includes a clip formation that can be clipped into the notch.

5. The mould assembly as claimed in claim 4, wherein the, or each, aperture has a rectangular profile and the tubular body of the, or each, mould insert has a rectangular cross section, such that the tubular body can be received through the aperture.

6. The mould assembly as claimed in claim 5, wherein the clip formation is positioned on one side of the tubular body and the clipping mechanism includes a lug that is positioned on an opposite side of the tubular body, such that the lug can be positioned at an inner end of the aperture and the mould insert can be pivoted so that the clip formation clips into the notch.

7. The mould assembly as claimed in claim 6, wherein stabilising formations are arranged on the tubular body to bear against the floor when the clip formation clips into the notch.

8. The mould assembly as claimed in claim 1, which includes at least one retention member that extends into the mould cavity and is shaped to retain the settable material in the mould cavity once the settable material has set.

9. The mould assembly as claimed in claim 8, wherein the, or each, retention member projects from the floor.

10. The mould assembly as claimed in claim 9, wherein the floor defines at least one retention plug aperture and the, or each, retention member is a retention plug that can be plugged into the respective retention plug aperture to be retained with respect to the floor.

11. A mould insert for a mould assembly for a skimmer box lid, the mould assembly having a mould including a floor and a sidewall extending from the floor, the floor and the sidewall defining a mould cavity into which a settable material can be introduced, the floor defining at least one aperture, the mould insert comprising:
a tubular body defining an elongate passage and being configured for attachment to the floor to extend from the floor to a height that is at least substantially equivalent to a height of the sidewall, such that the passage is in register with a respective aperture and such that, when the settable material is introduced into the mould cavity and subsequently sets, the mould body, the or each mould insert, and the settable material form the skimmer box lid with the, or each, passage extending through the skimmer box lid so that a suitable tool can be used to lift the skimmer box lid.

12. The mould insert as claimed in claim 11, which includes a clipping mechanism arranged on the tubular body so that the mould insert can be attached to the floor by being clipped onto a periphery of the aperture.

13. The mould insert as claimed in claim 12, wherein the clipping mechanism includes a clip formation that can be clipped into a notch, the, or each, aperture opening at a lower edge of the floor such that the floor and the sidewall define the notch.

14. The mould insert as claimed in claim 13, wherein the tubular body has a rectangular cross-section and the, or each, aperture has a rectangular profile so that the tubular body can be received through the aperture.

15. The mould insert as claimed in claim 14, wherein the clip formation is positioned on one side of the tubular body such that the lug can be positioned at an inner end of the aperture and the mould insert can be pivoted so that the clip formation clips into the notch.

16. The mould insert as claimed in claim 15, wherein stabilising formations are arranged on the tubular body to bear against the floor when the clip formation clips into the notch.

17. A method of forming a skimmer box lid using the mould assembly of claim 1, the method including the step of introducing the settable material into the mould cavity.

18. A skimmer box lid that comprises the mould assembly of claim 1 and a settable material in the mould cavity.
